(19) United States
(12) Patent Application Publication
(10) Pub. No.: US 2022/0284356 A1
(43) Pub. Date: Sep. 8, 2022

(54) INFORMATION PROCESSING APPARATUS, INFORMATION PROCESSING METHOD, AND NON-TRANSITORY COMPUTER READABLE MEDIUM

(71) Applicant: FUJIFILM BUSINESS INNOVATION CORP., Tokyo (JP)

(72) Inventors: Kengo TOKUCHI, Kanagawa (JP); Toru HATORI, Kanagawa (JP)

(73) Assignee: FUJIFILM BUSINESS INNOVATION CORP., Tokyo (JP)

(21) Appl. No.: 17/386,160

(22) Filed: Jul. 27, 2021

(30) Foreign Application Priority Data
Mar. 3, 2021 (JP) 2021-033668

(51) Int. Cl. G06Q 10/02; G07C 9/00; G06K 1/12; G06Q 30/02; H04L 29/06

(52) U.S. Cl. CPC G06Q 10/02; G07C 9/00904; G06K 1/121; G06Q 30/0284; H04L 63/08; H04L 63/108; G06F 3/12

(57) ABSTRACT

An information processing apparatus includes a processor configured to: provide a service to multiple users by receiving operations from the users; manage multiple first sites at a first location but not manage a second site at a second location different from the first location; authenticate a user utilizing a first site; and permit the authenticated user to utilize the first site.

### CROSS-REFERENCE TO RELATED APPLICATIONS

This application is based on and claims priority under 35 USC 119 from Japanese Patent Application No. 2021-033668 filed Mar. 3, 2021.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2002-216174 discloses a method of authenticating a reserver and recipient of a ticket when a kiosk terminal issues the ticket.

Japanese Unexamined Patent Application Publication No. 2002-149765 discloses an apparatus that, when a ticketing instruction is received from a user, transmits ticketing data to a ticketing device by reading the ticketing data from a ticketing database (DB) in a ticketing DB server via the Internet.

Japanese Unexamined Patent Application Publication No. 2002-42101 discloses an apparatus that issues a real ticket in response to the inputting of ticketing information and outputs transport information indicating a service deposit where a service related to issuing the real ticket is available.

Japanese Unexamined Patent Application Publication No. 2014-164450 disclose a system that includes a coupon management server delivering coupon information and a user device connected to the coupon management server via a network. The coupon management server electronically transmits the coupon information to the user device in. response to a request from a user.

Japanese Unexamined Patent Application Publication No. 2009-251043 discloses a system in which a coupon site of a coupon issuer is linked to websites of sales outlets and coupon information is transmitted to a user terminal that. has accessed the coupon site.

Japanese Unexamined Patent Application Publication No. 2007-58800 discloses a system in which an email or telephone is used to notify a user that it is reserved time, and a reservation is maintained or canceled depending on a reply responsive to the email or telephone.

### SUMMARY

Aspects of non-limiting embodiments of the present disclosure relate to permitting an apparatus providing a service in response to reception of an operation from multiple users to permit a user to utilize a site.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: provide a service to multiple users by receiving operations from the users; manage multiple first sites at a first location but not manage a second site at a second location different from the first location; authenticate a user utilizing a first, site; and permit the authenticated user to utilize the first site.

### BRIEF DESCRIPTION OF THE DRAWINGS

Exemplary embodiments of the present disclosure will be described in detail based on the following figures, wherein;

FIG. 1 illustrates a configuration of an information processing system of an exemplary embodiment;

FIG. 2 schematically illustrates an external view of a booth;

FIG. 3 is a block diagram illustrating a configuration of a terminal apparatus of the exemplary embodiment;

FIG. 4 illustrates a configuration of the information processing system of the exemplary embodiment;

FIG. 5 illustrates a configuration of the information. processing system; and

FIG. 6 illustrates a location in a space.

### DETA1LED DESCRIPTION

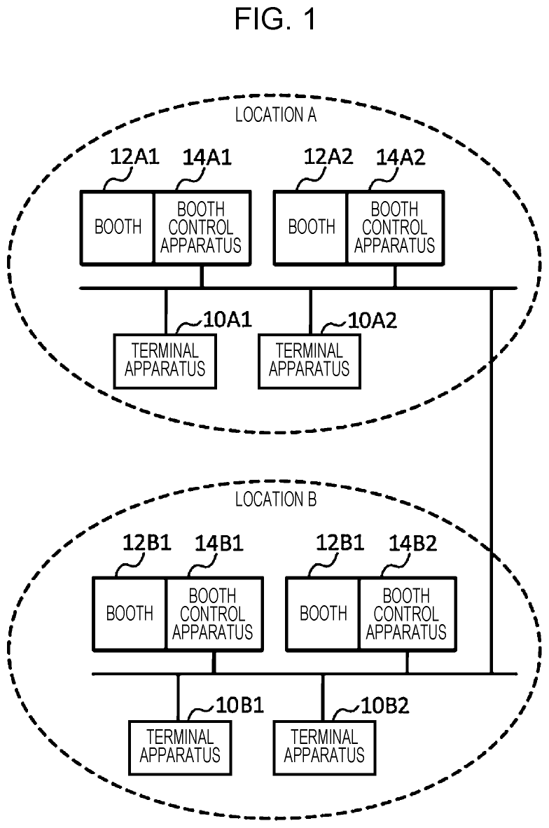

Referring to. FIG. 1, an information processing system of the exemplary embodiment is described below. FIG. 1 illustrates an example of a configuration of the information processing system of the exemplary embodiment.

The information processing system of the exemplary embodiment includes a terminal apparatus that manages a site at a location. The location herein refers to an area or region. For example, the site refers to a booth, conference room, an office such as a shared room or shared office, classroom, store, square or other partitioned spaces. The site may be an indoor site or outdoor site. The site may be looked by using an electronic lock. The site may be utilized free of charge or paid. The managing of the site may be managing the reservation of the site, permitting a user to utilize the site, not permitting a user to utilize the site, authenticating a user utilizing the site, and/or performing a billing process for the utilization of the site

FIG. 1 illustrates locations A and B, and terminal apparatuses 10A1, 10A2, 10B1, and 10B2. The terminal apparatuses 10A1 and 10A2 manage sites included in the location A and do not manage sites included in a location (such as a location B) other than the location A. The terminal apparatuses 10B1 and 10B2 manage sites included in the location B but do not manage sites included in a location (e.g., the location A) other than the location &.

Booths 12A1 and 12A2 as examples of site are installed at the location A. The terminal apparatuses 10A1 and 10A2 are installed at the location A and manage booths 12A1 and 12A2. Booths 12B1 and 12B2 as examples of site are installed at the location B. The terminal apparatuses 10B1 and 10B2 are installed at the location B and manage the booths 12B1 and 12B2.

The terminal apparatuses 10A1 and 10A2 manage reservations of the booths 12A1 and 12A2 installed at the location A, permit users to utilize the booths 12A1 and 12A2 do not permit users to utilize the booths 12A1 and 12A2, authenticate users utilizing the booths 12A1 and 12A2, and/or perform the billing process for the utilization of the booths 12A1 and 12A2. The terminal apparatuses 10B1 and 10B2 also manage the booths 12B1 and 12B2 installed at the location B.

The number of locations and the number of booths are described for exemplary purposes only. The process of the exemplary embodiment may be implemented at the location A and/or the location B. In a way similar to the way at the locations A and B, the process of the exemplary embodiment may be implemented at another location other than the locations A and 3. One or more booths may be installed at each of the locations A and B. One or more terminal apparatuses may be installed at each of the locations A and B. For example, a single terminal apparatus may manage one or more booths installed at the location A. This is true of the location R.

The information processing system of the exemplary embodiment includes a booth control apparatus controlling a booth serving as an example of the site. FIG. 1 illustrates booth control apparatuses 14A1, 14A2, 14B1, and 14B2.

The booth control apparatus 14A1 is installed at or near the booth 12A1 and controls the booth 12A1. The booth control apparatus 14A2 is installed at or near the booth 12A2 and controls the booth 12A2. The booth control apparatus 14B1 is installed at or near the booth 12B1 and controls the booth 12B1. The booth control apparatus 14B2 is installed at or near the booth 12B2 and controls the booth 12B2.

Controlling the booth signifies locking an electronic. lock on the booth, unlocking the electronic lock on the booth and/or controlling device such as lighting, air-conditioning, multi-function unit, display, speaker, microphone, and other devices).

The terminal apparatuses 10A1 and 10A2 may function. respectively as the booth control apparatuses 14A1 and 14A2. Similarly, the terminal apparatuses 10B1 and 10B2 may function respectively as the booth control apparatuses 14B1 and 14B2.

The information processing system of the exemplary embodiment may include a server that menaces booth reservations. For example, the server may manage the reservation for each booth, usage status of each booth, and user authentication. The whole management of the booths may be performed by the server. Alternatively, part of the management of the booths may be performed by the terminal. apparatus while the rest of the management may be performed by the server. For example, the booths may be collectively managed by the server.

If the terminal apparatuses 10A1, 10A2, 10B1, and 10B2 are not differentiated from each other, the terminal apparatuses 10A1, 10A2, 10B1, and 10B2 are collectively referred to as “the terminal apparatus 10.” If the booths 12A1, 12A2, 12B1, and 12B2 are not differentiated from each other, the booths 12A1, 12A2, 12B1, and 12B2 are collectively referred as “the booth 12.” If the booth control apparatuses 14A1, 14A2, 14B1, and 14B2 are not differentiated from each other, the booth control apparatuses 14A1, 14A2, 14B1, and 14B2 are collectively referred to as “the booth control device 14.”

The terminal apparatus 10 and booth control apparatus 14 have a function of communicating with another apparatus. The communication may be wired communication with cable or wireless communication. Specifically, each apparatus may be physically connected to another apparatus via a cable to exchange information. Each apparatus may transmit or receive information via wireless communication. The wireless communication may be near field communication or Wi-Fi (registered trademark). The near field communication may be Bluetooth (registered trademark), Radio Frequency Identifier (RFID), or NFC. Each apparatus may communicate with another apparatus via Local Area Network (LAN) and/or the Internet.

The terminal apparatus 10 has a function of managing the site and a function of providing a service in response Lo an operation received from multiple users. Specifically, the terminal apparatus 10 is ready to be operated by multiple users. The services include administrative services (e.g., a service of issuing a public certification document and a service of issuing official certification). In addition to the administrative services, the terminal apparatus 10 may sell tickets or provide a variety of reservation service. By communicating with the server providing services via the LAN or the Internet, the terminal apparatus 10 may function as a man-machine interface that provides users with the services provided by the server. The terminal apparatuses 10 may be installed at companies, schools, libraries, stores, stations, and public facilities. The terminal apparatuses 10 also may be installed at any other sites.

The booth 12 is an example of a space or site rented to users. Fut example, partitioned spaces, private rooms, seats, or compartments are examples of the booth 12. The booth 12 is rented to a user with locking managed. For example, the booth 12 has a door that is locked with an electronic lock. Rental reservation of the booth 12 is managed by the terminal apparatus 10 that manages the booth 12. The booth 12 may be equipped with lighting, power supply, air-conditioning and other devices (e.g., printers, scanners, copy machines, multi-function apparatus (for example, an apparatus having a print function and scan function)). The booth 12 may also be equipped with a variety of sensors. For example, such sensors may include a human sensor detecting the presence or absence of a person in the booth 12, a temperature sensor detecting temperature within the booth 12, a humidity sensor detecting humidity within the booth 12, an odor sensor detecting odor within the booth 12, a pressure sensor detecting pressure within the booth 12, a camera photographing the inside of the booth 12, and/or a microphone picking up sound within the booth 12.

The booth control apparatus 14 controls the electronic look installed at the booth 12 serving as a control target of the booth control apparatus 14 and/or controls a variety of devices installed at the booth 12. The booth control apparatus 14 includes a communication device, use interface (UI), memory, and processor. The electronic lock and each device at the booth 12 are controlled by the processor the booth control apparatus 14.

The terminal apparatus 10 is an example of an information processing apparatus. The terminal apparatus 10 may include the booth control apparatus 14.

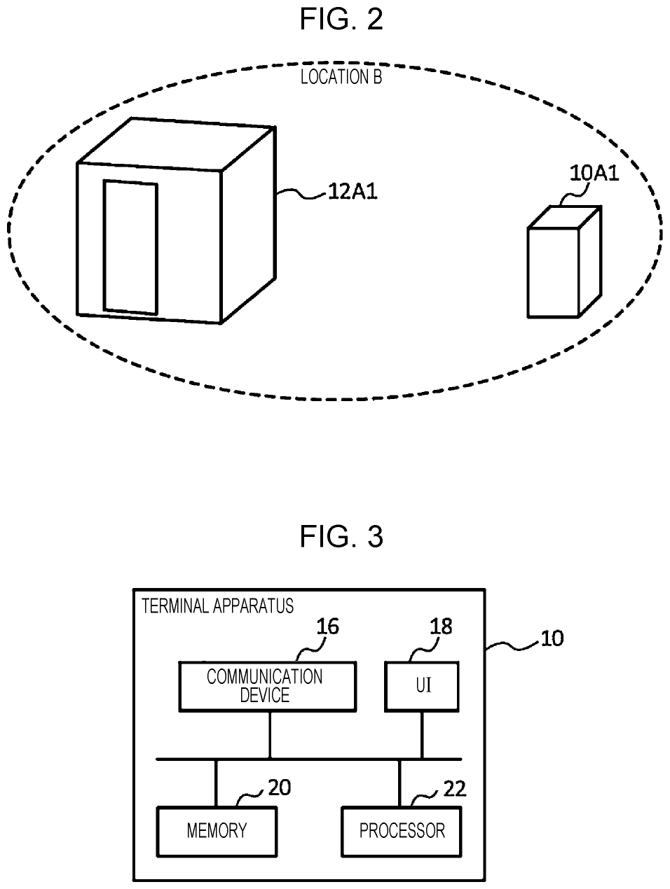

FIG. 2 is a schematic external view of the booth 12A1. Although FIG. 2 illustrates the booth 12A1 and the terminal apparatus 10A1, the terminal apparatus 10A2 and booth 12A2 are also installed at the location A. Referring to FIG. 2, the, terminal apparatus 10A1 is spaced apart from the booth. 12A1. The terminal apparatus 10A1 may be installed in the vicinity of the booth 12A1. The booth 12A1 has a door that may be locked with an electronic lock A user may enter the booth 12A1 by unlocking the door. The same is true of the other booths 12. At the location B, the terminal apparatuses 10B1 and 10B2 may be in the vicinity of the booths 12B1 and 12B2 or may be spaced apart from the booths 12B1 and 12B2.

Referring to FIG. 3, a hardware configuration of the terminal apparatus 10 is described. FIG. 3 illustrates the hardware configuration of the terminal apparatus 10. The terminal apparatus 10 includes a communication device 16, UI 18, memory 20, and processor 22.

The communication device 16 is a communication interface including a communication chip and a communication circuit and has a function of transmitting or receiving information to and from another apparatus. The communication device 16 may have a wireless communication function or a wired communication function. The communication device 16 may communicate with another apparatus by using the near field communication or via a communication network, such as the LAN and/or the Internet.

The UI 18 is a user interface and includes a display and/or an input device. The display is a liquid-crystal display or an electro luminescent (EL) display. The input device used may include a keyboard, mouse, input key, and/or operation panel. The UI 18 may be a touch panel serving as the display and the input device. The UI 18 may also include a microphone and/or a speaker.

The memory 20 includes one or more storage regions storing data. The memory 20 may be a hard disk drive (HDD), solid-state drive (SSD), a variety of memories (such as random-access memory (RAM) or read-only memory (ROM)), other storage device (such as an optical disk), or a combination thereof. The terminal apparatus 10 includes one or more memories 20.

The processor 22 is configured to control the operation of each element in the terminal apparatus 10. The processor 22 may include a memory.

The processor 22 in the terminal apparatus 10A1 manages the reservation of the booths 12A1 and 12A2. When the booth 12A1 has been reserved by a user, the user having reserved the booth 12A1 is permitted to use the booth 12A1. If the booth 12A1 has been reserved with usage time which is specified by the user and throughout which the booth 12A1 is available, the user is permitted to use the reserved booth 12A1 during the usage time. For example, the usage time is defined by date and time band. Similarly, the processor 22 in the terminal apparatus 10A2 manages the reservation of the booths 12A1 and 12A2. The processors 22 in the terminal apparatuses 10B1 and 10B2 manage the reservations of the booths 12B1 and 12B2.

The memories 20 in the terminal apparatuses 10A1 and 10A2 store reservation management information used to manage the reservations of the booths 12A1 and 12A2 installed at the location A. Concerning each booth 12, the reservation management information includes, in a linked form, booth identification information (e.g., booth identification (ID) or booth name) identifying a reserved booth 12, usage time information indicating the usage time of the reserved booth 12, user identification information (e.g., user ID or user name) identifying a user having reserved the booth 12, information indicating a usage status of the booth 12, and usage information used to utilize the booth 12 during the usage time.

The usage information includes a password and/or key information. For example, the processor 22 in the terminal apparatus 10 generates the usage information that is different from reservation to reservation. The user may utilize the booth 12 by using the usage information. For example, if the booth 12 is locked, the usage information is used to unlock the booth 12. The usage information may be displayed on a display in the terminal apparatus 10, transmitted to a device (such as a personal computer (PC), tablet PC, smart phone, or cellular phone) used by the user having reserved the booth 12, and/or printed on a paper sheet. For example, the processor 22 in the terminal apparatus 10 may generate a bar code or a two-dimensional (2D) code by coding the usage information, display the bar code or 2D code on the display, transmit the bar code or 2D code on the device used by the user, and/or print the bar code or 2D code on a paper sheet.

The processor 22 in the terminal apparatus 10A1 and the processor 22 in the terminal apparatus 10A2 communicate with each other and share the reservation management information on the booths 12A1 and 12A2 installed at the location A. For example, if the booth 12A1 is reserved by the terminal apparatus 10A1 or the terminal apparatus 10A2, the processor 22 in each of the booths 12A1 and 12A2 stores and manages the reservation management information of the same contents on the memory 20 by mutually synchronising the reservation management information.

The memories 20 in the terminal apparatuses 1031 and 10B2 store the reservation management information used to manage the reservations of the booths 12B1 and 2 2B2 installed at the location B. The processor 22 in the terminal apparatus 10B1 and the processor 22 in the terminal apparatus 10B2 communicate with each other and share the reservation management information on the booths 12B1 and 12B2 installed at the location B. The terminal apparatuses 10A1, 10A2, 10B1, and 10B2 may communicate with each other and share the reservation management information on the booths 12A1 and 12A2 installed at the location A and the reservation management information on the booths 12B1 and 12B2 installed at the location B.

Examples of the exemplary embodiment are described below.

### FIRST EXAMPLE

In a first example, the terminal apparatus 10A1 is operated by a user. The process described below is also applicable when the terminal apparatus 10A2 is operated by the user. The same is true of the terminal apparatuses I0B1 and 10B2.

As described above, the processor 22 in the terminal apparatus 10A1 manages the booths 12A1 and 12A2 installed at the location A but does not manage the booths 1281 and 1282 installed at the location B. The location A is an example of a first location, the location 3 is an example of a second location, the booths 12A1 and 12A2 are examples of a first site, and the booths 12B1 and 12B2 are examples of a second site.

The processor 22 in the terminal apparatus 10A1 authenticates users utilizing the booths 12A1 and 12A2 and permits a successfully authenticated user to use the booths 12A1 and 12A2.

User X may now authenticate user X himself or herself by using the terminal 10A. The authentication herein may be performed by using an IP, password or biometric information (biometric authentication). For example, information to authenticate the user X is registered on the terminal apparatus 10, the server managing each terminal apparatus 10, or an authentication server, and the registered information is checked against information entered to the terminal apparatus 10A to authenticate the user

The biometric information may include a variety of information emitted by living things. For example, the biological information includes information indicating the activity of the brain of human (such as electroencephalogram, cerebral blood flow, or cerebral magnetic field signal), information indicating the pulse rate, myoelectric information indicating the myoelectric wave, information. indicating saliva (e.g., information indicating saliva production), information indicating the pulse wave, information indicating the blood pressure, information indicating the blood flow, information indicating the pulse, information indicating the heart rate, information indicating the electrocardiographic waveform, information, indicating the eye movement, information and the body temperature, information indicating the amount of perspiration, information indicating the gaze, voice information, human movement information, information indicating the facial expression, information determined by a biomarker, information indicating breathing, information indicating the fingerprint, and/or information obtained from the body fluid (such as blood). The biometric information may be derived from a potential detected from the living thing. For example, the biological information may include the electroencephalogram that results from measuring a fine electric current, generated from the activity of the brain, the electro-cardiogram that results from measuring a fine current generated from the heart beat, the electromyogram that results from measuring a fine current generated from the activity of muscles, and/or skin potential that, results from measuring a fine current generated from the skin. These piece of information are described for exemplary purposes only and any other piece of the biological information may be utilized.

If the user X has been successfully authenticated, the processor 22 in the terminal apparatus 10A1 permits the user X to utilize the booths 12A1 and 12A2 managed by the terminal apparatus 10A1. For example, the user X specifies the booth 12 the user X wants to use by operating the terminal apparatus 10A1. When the booth 12A1 is specified by the user X, the processor 22 in the terminal apparatus 10A1 transmits to the booth control apparatus 14A1 in the booth 12A1 an unlocking instruction to instruct the booth 12A1 to be unlocked. Upon receiving the unlocking instruction, the booth control, apparatus 14A1 unlocks the locked booth 12A1. The user X may thus enter the booth 12A1 to utilize the booth 121.

When the use: X has been authenticated and has specified the booth 12A1, the processor 22 in the terminal apparatus 10A1 may provide the user X with the usage information used to utilize the booth 12A1. For example, the processor 22 in the terminal apparatus 10A1 provides the user X with the usage information to unlock the booth 12A1 (e.g., ID, password, bar code, or 2D code). The processor 22 in the terminal apparatus lam causes the display to display the usage information, transmits the usage information to the device of the user X, and/or prints the usage information on a paper sheet. For example, the terminal apparatus 10A1 includes a printer, and the processor 22 in the terminal apparatus 10A1 outputs the bar code and/or 2 code by printing the bar code and/or 2D code on the paper sheet. The paper sheet indicating the usage information may be issued for the user X.

The processor 22 in the terminal apparatus 10A1 transmits to the booth control apparatus 14A1 the usage information provided to the user X.

The user X may utilize the booth. 12A1 by using the provided usage information. For example, by using the usage information, the user X may unlock the locked booth 12A1. Specifically, if the 2D code representing the usage information is printed or the paper sheet, the user X may move to the booth 12A1 with the paper sheet. If the user X holds the 2D code over a reading device installed at the booth 12A1, the reading device reads the 2D code. The booth control apparatus 14A1 acquires the usage information from the 2D code by analyzing an image that is generated through the reading. For example, the booth control apparatus 14A1 acquires original usage information by decoding the 2D code. If the usage information matches the usage information transmitted from the terminal apparatus 10A1, the booth control apparatus 14A1 may unlock the booth 12A1. The user X enters the booth 12A1 to use the booth 12A1. The 2D code may be displayed on a display of the device of the user X instead of being printed.

If the booth 12A1 is reserved by the user X, the processor 22 in the terminal apparatus 10A1 provides the user X with the usage information responsive to the reservation. For example, if time (10:00-11:00) to utilize the booth 12A1 is reserved, the usage information is effective during the reserved time. The processor 22 in the terminal apparatus 10A1 may provide the user X with the usage information several times within the reserved time and may not necessarily provide the user X with the usage information outside the reserved time. Each time the user X is authenticated at the terminal apparatus 10A1, the processor 22 in the terminal apparatus 10A1 provides the user X with the usage information by printing the usage information used to utilize the booth 12A1. The processor 22 in the terminal apparatus 10A1 may validate latest usage information and invalidate earlier usage information. Fox example, each time the user X is authenticated, the processor 22 in the terminal apparatus 10A1 provides the user X with the usage information of different contents and transmits the usage information to the booth control apparatus 14A1. In this case, the processor 22 in the terminal apparatus 10A1 may unlock the booth 12A3 by using the latest usage information and is unable to unlock the booth 12A1 by using the usage information provided earlier.

If multiple users utilize the booth 12A1, the processor 22 in the terminal apparatus 10A1 may provide each user with the usage information. For example, the processor 22 in the terminal apparatus 10A1 may issue on a per user basis a paper sheet with the usage information printed thereon. The usage information on the users may be the same or different. Each user may utilize the booth 12A1 by unlocking the booth 12A1 with the usage information provided for the user. The processor 22 in the terminal apparatus 10A1 may set an upper limit on the number of times in providing the usage information. For example, the processor 22 in the terminal apparatus 10A1 may set the upper limit, on the number of issues of the paper sheet with the usage information printed thereon and restricts the issuance of the paper sheet if the number of issues exceeds the upper limit.

The booth 12A1 may be permitted to be used if the usage information to unlock the booth 12A1 is combined with authentication information as another piece of information. For example, the authentication information includes biological information on the user X, information registered on an employee ID card of the user X, or personal information on the user X stored on an integrated circuit (IC) card of the user X. When the user X unlocks the booth 12A1 by using the usage information, the biological information on the user X, the information registered on the employee ID card of the user X, or the personal information stored on the IC card of the U3er X is entered as the authentication information on an input device installed at the booth 12A1. The booth control apparatus 14A1 receives the usage information and the input authentication information and manages a combination of these pieces of information. When the user X goes out of the booth 12A1, the booth 12A1 is locked again. When the user X enters the booth 12A1 later, the usage information and authentication information are entered on the booth control apparatus 14A1. If the input combination of the usage information and authentication information matches the combination managed in the booth control apparatus 14A1, the booth control apparatus 14A1 unlocks the booth 12A1. If the input combination of the usage information and authentication. information fails to match the combination managed in the booth control apparatus 14A1, the booth control apparatus 14A1 does not unlock the booth 12A1. If the usage in is provided to a third person other than the user X, the third person may attempt to utilize the booth 12A1. The process described above controls the utilization of the booth 12A1 by the third person.

If the booth 12A1 is reserved, the usage information on the user X may be registered on the terminal apparatus 10A1. When the booth 12A1 is used, the booth 12A1 mass be unlocked by using the registered usage information. In this case, the usage information such as the 2D code may not necessarily be issued to the user X.

When the paper she having the usage information printed thereon is issued, the booth 12A1 or the terminal apparatus 10A1 may be equipped with a shredder to destroy the paper sheet.

When the terminal apparatus 10A1 is operated by a user, the processor 2 in the terminal apparatus 10A1 may not necessarily permit the user to utilize the terminal apparatus 10A1 until a predetermined period of time has elapsed. When the predetermined period of time has elapsed, the processor 22 in the terminal apparatus 10A1 permits the user to utilize the terminal apparatus 10A1.

In an example operation, after authenticating the user utilizing the booths 12A1 and 12A2 serving as a first site, the processor 22 in the terminal apparatus 10A1 does not perform a process including authenticating the user until the predetermined period of time has elapsed. The process includes an operation of reserving the booth 12. When the predetermined period of time has elapsed, the processor 22 in the terminal apparatus 10A1 performs the process including the operation of authenticating the user. Specifically, the processor 22 in the terminal apparatus 10A1 may not necessarily receive an operation from the user via the UI 18 until the predetermined period of time has elapsed and may invalidate the received operation. For example, the processor 22 in the terminal apparatus 10A1 may not necessarily receive the operation from the user via a touch panel in the UI 18 and may invalidate the received operation. Until the predetermined period of time has elapsed, the processor 22 in the terminal apparatus 10A1 may cause the display to display a message telling that the user is riot permitted Lo utilize the terminal apparatus 10A1 (e.g., a message telling that the processor 22 in the terminal apparatus 10A1 is not ready to receive an operation or a message that, requests the user to wait for some time before the operation).

The UT 18 includes a touch panel. Until a predetermined period of time has elapsed since the operation of a user on the touch panel, the processor 22 in the terminal apparatus 10A1 does not permit the user to operate the terminal apparatus 10A1 (e.g., operate the touch panel).

In another example operation, when a cleaner presses a compete button after cleaning the touch panel, the processor 22 in the to apparatus 10A1 may permit the user to operate the touch panel.

If there are no other users utilizing the booths 12A1 and 12A2, the processor 22 is each of the terminal apparatuses 10A1 and 10A2 may permit an authenticated user. (e.g., the user X) to change the booths. No other users utilizing the booths 12A1 and 12A2 signifies that so other users currently use the booths 12A1 and 12A2 or the booths 12A1 and 12A2 are not reserved by any other users.

For example, the booth 12A1 is now reserved by the user X. If the booth 12A2 is not reserved by anyone, the processor 22 in each of the terminal apparatuses 10A1 and 10A2 permits the user X to use the booth 12A2 instead of the booth 12A1. For example, if the user X provides to the terminal apparatus 10A1 a request to change a usage target booth from the booth 12A1 to the booth 12A2 by using the terminal apparatus 10A1, the processor 22 in the terminal apparatus 10A1 permits the user X to use the booth 12A2 instead of the booth 12A1 and provides the user X with the usage information to utilize the booth 12A2 (such as the 2D code). In this case, the processor 22 in the terminal apparatus 10A1 invalidates the usage information used to utilize the booth 12A1. Time to use the booth 12A2 may be modified.

The processor 22 in each of the terminal apparatuses 10A1 and 10A2 may manage usage logs of the booths 12A1 and 12A2 on each user and provide the user with information used to reduce usage fees of the booths 12A1 and 12A2. For example, the processor 22 in each of the terminal apparatuses 10A1 and 10A2 provides information used to reduce the usage fees of the booths 12A1 and 12A2 to a user who has the number of usages of the booths 12A1 and 12A2 higher than a threshold. For example, providing the information to reduce the usage fee is issuing a discount ticket or coupon, transmitting information on a discount or coupon to an account of the user (e.g., transmitting information by using email or social network service (SNS)), or displaying information on the display of the UI 18.

The processors 22 in the terminal apparatuses 10A1 and 10A2 may provide the user with information to reduce the usage fee of the booth 12 with the usage logs of the booths 12B1 and 12B2 included in the above-described usage log.

The processors 22 in the terminal apparatuses 10A1 and 10A2 may transmit, to the account of the user, information on surroundings of the booth 12 (e.g., information on surrounding stores and advertising information) having the number of usages equal to or higher than the threshold.

The processor 22 in each of the terminal apparatuses 10A1 and 10A2 may cause the display in the UI 18 to display the usage status of the booths 12A1 and 12A2. The usage status may indicate whether or not the booths 12A1 and 12A2 are being currently used or may indicate reserved or unreserved time band.

If the use of the booth 12 is a paid service, the processor 22 in the, terminal apparatus 10 may issue a receipt for each usage of the booth 12 or a receipt for all usages of the booth 12 during a predetermined period of time. If a corporation utilizes the booth 12, a receipt may be issued in response to a request of a person in charge of the corporation. For example, if the usage log of the booth 12 also manages attendance of an employee of the corporation, a receipt may be issued each time the employee utilizes the booth 12. Specifically, a receipt is issued when the payment is per formed at the booth 12.

The processor 22 in the terminal apparatus 10 provides a variety of services, including administrative services, in. addition to managing the booth 12. The processor 22 in the terminal apparatus 10 may guide the user to a booth 12 supporting a service to be utilized by the user. In this case, the processor 22 in the terminal apparatus 10 may reserve the guide target booth 12 for the user. For example, guiding the user to the booth 12 includes displaying information used to identify the booth 12 on the display in the terminal apparatus 10, transmitting the information used to identify the booth 12 to the account of the user by using email or SNS, outputting by voice the information used to identify the booth 12, displaying a map to guide the user to the booth 12, and transmitting the map to the account of the user by using email or SNS.

In accordance with the service utilized by the user, the processor 22 in the terminal apparatus 10 predicts a next action of the user and guides the user to the booth 12 that may help the user in the next action.

When the user utilizes an administrative service on the terminal apparatus 10, the terminal apparatus 10 prints an official certificate (e.g., family register, certificate of residence, or tax certificate). The processor 22 in the terminal apparatus 10 predicts a next action of the user in accordance with the printed certificate. The issuance of an official certificate may be possibly followed by the generation of some kind of application form. To this end, it is likely that, stationery (e.g., paste, scissors, and envelope is used. The processor 22 is the terminal apparatus 10 guides the user to the booth 12 where the stationery is available. The memory 20 in each the terminal apparatus 10 stores information indicating a device and other things (e.g. stationery) available at the booth 12. In accordance with the, information, the processor 22 in the terminal apparatus 10 searches a booth 12 where the stationery is available and guide the user to that booth 12. The processor 22 in the terminal apparatus 10 may also guide the user to a store that sells the stationery.

If the booth 12 managed by the terminal apparatus 10 is used, the professor 22 in the terminal apparatus 10 causes the dis in the terminal apparatus 10 to display information concern a variety of services including administrative services. If the booth 12 managed by the terminal apparatus 10 is not used, the processor 22 in the terminal apparatus 10 may cause the dis lay in the terminal apparatus 110 to display information concerning the reservation of the booth 12 managed by the terminal. apparatus 10. These, displays may be switched in response to an instruction from the user.

If the booths 12A1 and. 12A2 are being utilized, the processor 22 in the terminal apparatus 10A1 causes the display in the terminal apparatus 10A1 to display the information concerning the variety of services. If the booths 12A1 and 12A2 are not currently used, the processor 22 in the terminal apparatus 10A1 causes the display in the terminal apparatus 10A1 to display information concerning the reservation of the booths 12A1 and 12A2.

Displaying the information concerning the variety of services includes displaying a menu screen or an icon used. to utilize a service leaving the information concerning the reservation of the, booth 12 includes displaying a reservation screen or an icon used to reserve the booth 12.

If the booths 12A1 and 12A2 are being utilized, the processor 22 in the terminal apparatus 10A1 causes the display to display the information on the variety of services in a size larger than the information on the reservation of the booths 12A1 and 12A2. If the booths 12A1 and 12A2 are not being utilized, the processor 22 in the terminal apparatus 10A1 causes the display to display the information on the reservation of the booths 12A1 and 12A2 in a size larger than the information on the variety of services.

As described above., the terminal apparatus 10A1 is operated to utilize the booth 12A1. The process described above is also performed if the booth 12A2 is being utilized or if the booths 12A1 and 12A2 are being utilized wit the terminal apparatus 10A2 operated. The process describe above is also performed if the booths 1221 and 1222 are being utilized with the terminal apparatuses 10B1 and 10B2 operated.

If multiple terminal apparatuses 10 (e.g., the terminal apparatuses 10A1 and 10A2) are installed at the location A as illustrated in FIG. 1, one of the terminal apparatuses 10 (e.g., the terminal apparatus 10A1) may guide the user to another terminal apparatus 10 of the terminal apparatuses 10 (e.g., the terminal apparatus 10A2). For example, the processor 22 in the terminal apparatus 10A1 causes the display in the terminal apparatus 10A1 to display information identifying the terminal apparatus 10A2 or a map for the terminal apparatus 10A2, transmits to the device of the user the information Identifying the terminal apparatus 10A2 or the map for the terminal apparatus 10A2, or outputs by voice the information identifying the terminal apparatus 10A2 or the map for the terminal apparatus 10A2. The same is true of the operation of the terminal apparatus 10A2 and the operation of the terminal apparatuses 10 installed at the location B.

A terminal apparatus 10 installed at the location A (e.g., the terminal apparatus 10A1 or 10A2) may guide the user to a terminal apparatus 10 installed at the location B (e.g., the terminal apparatus 10B1 or 1082). Similarly, a terminal apparatus 10 installed at the location B may also guide the user to a terminal apparatus 10 installed at the location A.

If the terminal apparatus 10A1 or 10A2 malfunctions (with communication fault or printing fault), a reserved booth 12 (e.g., the booth 12A1) may be unlocked by using the device of the user (such as a personal computer (PC) or smart phone). For example, the user may access a web site to reserve the booth 12 by using the user's own device, acquire the usage information via the web site, and unlock the booth 12A1 to use the booth 12A1 by using the usage information. As another example, the reserved booth 12A1 may be automatically unlocked.

If the terminal apparatus 10A1 or 10A2 installed at the location A malfunctions (e.g., the terminal apparatus 10A1 may be unable to provide the user with the usage information on the booths 12A1 and 12A2), the user may not be permitted to use the booth 12A1 or 12A2 installed at the location A. In such a case, the user may be permitted to use the terminal apparatus 10 installed at the location B (e.g., the terminal apparatus 10B1 or 10B2). For example, if the processor 22 in the terminal apparatus 10B1 installed at the location B has detected a fault in the terminal apparatus 10A1 or 10A2 installed at the location A, the processor 22 in the terminal apparatus 10B1 provides the user with the usage information on the booths 12A1 and 12A2 installed at the location A. The same is true of the operation of the terminal apparatus 10B2. For example, the processor 22 in each of the terminal apparatuses 10B1 and 1QB2 installed at the location B communicates with the terminal apparatuses 10A1 and 10A2 installed at the location A to exchange information indicating operation status and thus recognizes the operation statuses of the other terminal apparatuses 10. If the processor 22 in each of the terminal apparatuses I0B1 and 1GB2 has detected a signal indicative of a fault in the terminal apparatus 10A1 or 10A2, the processor 22 in each of the terminal apparatuses 10B1 and 10B2 provides the user with the usage information on the booths 12A1 and 12A2. If the terminal apparatus 10B1 or 10B2 installed at the location B malfunctions, the processor 22 in each of the terminal apparatuses 10A1 and 10A2 installed at the location A provides the user with the usage information on the booths 12B1 and 12B2 installed at the location B.

If all the terminal apparatuses 10 (e.g., the terminal apparatuses 10A1 and 10A2) installed at the location A malfunction, a terminal apparatus 10 installed at the location B may permit the user to utilize the booths 12A1 and 12A2 installed at the location A. If at least one of the terminal apparatuses 10 installed at the location A malfunctions, a terminal apparatus 10 installed at the location B may permit the user to utilize the booths 12A1 and 12A2.

### SECOND EXAMPLE

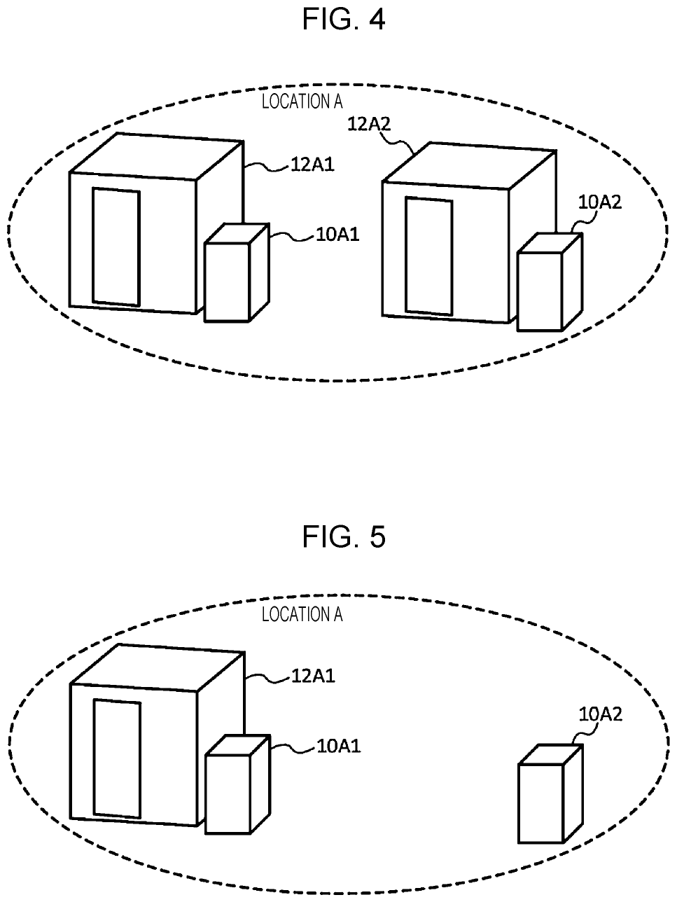

A second example of the exemplary embodiment is described with reference to FIG. 4. FIG. 4 illustrates an example of configuration of the information processing system of the exemplary embodiment.

In the second example, the terminal apparatus 10A1 is installed is the vicinity of the booth 12A1 and the terminal apparatus 10A2 is installed in the vicinity of the booth 12A2. In this configuration, one terminal apparatus 10 corresponds to one booth 12. The terminal apparatus 10A1 manages the booth 12A1 but does not manage the booth 12A2. The terminal apparatus 10A2 manages the booth 12A2 but does not manage the booth 12A1. For example, the processor 22 in the terminal apparatus 10A1 reserves the booth 12A1 and. provides the user with the usage information on the booth 12A1. The processor 22 in the terminal apparatus 10A2 reserves the booth 12A2 and provides the user with the usage information, on the booth 12A2. The same is true of the terminal apparatus 10 and the booth 12 installed at the location B.

If the booth 12A1 managed by the terminal apparatus is not being utilized, the processor 22 in the terminal apparatus 10A1 may cause the display in the terminal apparatus 10A1 to display information indicating that the booth 12A1 is available, or may output the information by voice. The same is true of the operation of the terminal apparatus 10A2. If the booth 12A1 managed by the terminal apparatus 10A1 is being utilized, the processor 22 in the terminal apparatus 10A1 may cause the display in the terminal apparatus 10A1 to display information on the variety of services including administrative services or may output the information by voice.

### THIRD EXAMPLE

A third example, of the exemplary embodiment is described with reference to FIG 5. FIG. 5 illustrates an example of configuration of the information processing system of the exemplary embodiment.

In the third example, the terminal apparatus 10A1 is installed in the vicinity of the booth 12A1. The terminal apparatus 10A2 is installed farther apart from the booth 12A1 than the terminal apparatus 10A1.

Referring to FIG. 5, the booth 12A1 may be reserved by the terminal apparatus 10A1 or the terminal apparatus 10A2.

In the third example, if the booth 12A1 is reserved by a terminal apparatus 10 (e.g., the terminal apparatus 10A2) other than the terminal apparatus 10A1, the processor 22 in the terminal apparatus 10A1 permits a user having reserved the booth 12A1 (e.g., the user X) to utilize the booth 12A1 after authenticating the user X. For example, if the user X has reserved the booth 12A1 by operating the terminal apparatus 10A2, the, processor 22 in the terminal apparatus 10A2 provides the user X with the usage information on the booth 12A1. For example, the processor 22 in the terminal apparatus 10A2 issues a paper sheet with the usage information printed thereon, causes the display to display the usage information, or transmits the usage information to the account of the user X. The processor 22 in the terminal apparatus 10A2 transmits the usage information on the booth 12A1 to the terminal apparatus 10A1 installed in the vicinity of the terminal apparatus 10A1. The processor 22 in the terminal apparatus 10A1 thus recognizes that the booth 12A1 has been reserved by the user X. In the same way as in the first example, the usage time of the booth 12A1 may be reserved as well.

The user X moves to the booth 12A1 and enters the usage information onto the terminal apparatus 10A1 installed in the vicinity of the booth 12A1. For example, if the usage information is represented by the 2D code, a reading device in the terminal apparatus 10A1 is caused to read the 2D code and the usage information is thus entered to the terminal apparatus 10A1. The processor 22 in the terminal apparatus 10A1 authenticates the user X in accordance with the entered usage information. If the entered usage information matches the usage information that has been transmitted from the terminal apparatus 10A2 used to reserve the booth 12A1 to the terminal apparatus 10A1, the processor 22 in the terminal apparatus 10A1 permits the user X to utilize the booth 12A1. For example, the processor 22 in the terminal apparatus 10A1 unlocks the booth 12A1. The user X may thus utilize the booth 12A1. If the entered usage information does not match usage information transmitted from the terminal apparatus 10A2 to the terminal apparatus 10A1, the processor 22 in the terminal apparatus 10A1 does not permit the user X to utilize the booth 12A1. For example, the processor 22 in the terminal apparatus 10A1 does not unlock the booth 12A1.

The booth 12 may or may not be permitted to be used in accordance with a combination of multiple terminal. apparatuses 10. For example, in accordance with the usage information that the user has received from the terminal apparatus 10A1, the processor 22 in the terminal apparatus 10A1 permits the user to utilize the booth 12A1. In accordance with the usage information that the user has received from a specific terminal apparatus 10 (e.g., the terminal apparatus 10A2) that is other than the terminal apparatus 10A1 and has a specific relation with the terminal apparatus 10A1, the processor 22 in the terminal apparatus 10A1 permits the user to utilize the booth 12A1. If the terminal apparatus 10A1 receives the usage information that the user has received from another terminal apparatus 10 and that has no specific relation with the terminal apparatus 10A1, the processor 22 in the terminal apparatus 10A1 does not permit the user to utilize the booth 12A1. The same is true of the operation about the terminal apparatus 10A2.

If a user (e.g., the user X) has reserved the booth 12A1 on a terminal apparatus 10 (e.g., the terminal apparatus 10A2) other than the terminal apparatus 10A1, the processor 22 in the terminal apparatus 10A1 may cause the display in the terminal apparatus 10A1 to display information identifying the user X (e.g., the name or the account of the user X). For example, the processor 22 in the terminal apparatus 10A1 causes the display to display information Indicating that the booth 12A1 has been by the user X. Information indicating reservation time may also be displayed. In this way, the user X may recognize the booth 12A1 that the user X is going to utilize. Another user may also recognize that the booth 12A1 has been reserved.

The processor 22 in the terminal apparatus 10A1 installed in the vicinity of the booth 12A1 permits a user to utilize the booth 12A1 after authenticating the user having reserved the booth 12A1. If the processor 22 in the terminal apparatus 10A1 detects a user when the booth 12A1 is not reserved, the processor 22 in the terminal apparatus 10A1 may cause the display in the terminal apparatus 10A1 to display information concerning a variety of services including administrative services. For example, a user may be detected by a variety of sensors, including a camera, installed on the terminal apparatus 10A1 and in the surrounding areas of the terminal apparatus 10A1 and the booth 12A1. Through user detection, a user approaching the terminal apparatus 10A1 or a user present around the terminal apparatus 10A1 may be detected. If a user approaches the terminal apparatus 10A1 with the booth 12A1 not reserved or a user is present around the terminal apparatus 10A1, there is a possibility that the user wants to utilize the terminal apparatus 10A1 for purposes other than utilizing the booth 12A1. In order to unset such a request of the user, the processor 22 in the terminal apparatus 10A1 causes the display in the terminal apparatus 10A1 to display information concerning the variety of services including administrative services. The processor 22 in the terminal apparatus 10A1 may causes the display to display the information concerning the variety of services including administrative services (e.g., a menu screen) in a size larger than a screen used to reserve the booth 12A1.

### Modification

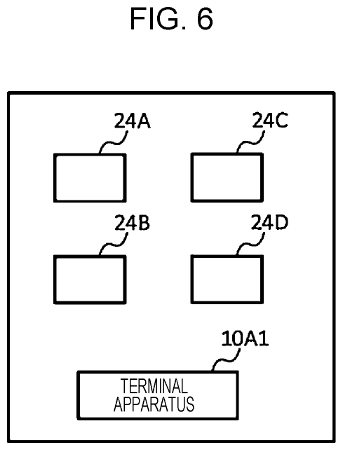

Modification of the examples is described with reference to FIG. 6. FIG. 6 illustrates a location in a space. For example, FIG. 6 is an overhead view of a store having seats 24A, 24B, 24C, and 24D. The terminal apparatus 10A1 is installed in the store. The store is an example of the location and the seats 24A, 248, 24C, and 24D are examples of sites. The processor 22 in the terminal apparatus 10A1 manages the reservation and utilization of the seats 24A, 243, 24C, and 24D. A management device having an authentication function and a locking function is installed at each of the seats 24A, 24B, 24C, and 24D. The management device may communicate with the terminal apparatus 10A1.

The processor 22 in the terminal apparatus 10A1 authenticates a user having reserved the seat 24A. If the user la successfully authenticated, Lite processor 22 in the terminal apparatus 10A1 permits the user to utilize the seat 24A. For example, the processor 22 in the terminal apparatus 10A1 transmits an instruction to unlock the seat 24A to the management device installed at the seat. 24A. Upon receiving the instruction, the management device unlocks the seat 24A. In this way, the user having reserved the seat 24A may utilize the seat 24A.

The exemplary embodiment may be applied to manage the seats in the store in this way. The exemplary embodiment may also be applied to manage the site.

Each of the functions of the terminal apparatus 10 and booth control apparatus 14 is implemented by a combination of hardware and software. For example, each function may be implemented when the processor in each apparatus reads a program from the memory and executes the program in each apparatus. The program may be stored onto the memory via a recording medium, such as a compact disk (CD) or a digital versatile disk (DVD), or via a communication network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications/thereby enabling others stilled in the art to understand the disclosure for various embodiments and with the various modifications as are suited to the particular use contemplated. It is intended that the scope of the disclosure be defined by the following claims and their equivalents.

What claimed is:

1. An information processing apparatus comprising:
a processor configured to:
provide a service to a plurality of users by receiving operations from the users;
manage a plurality of first sites at a first location but not manage a second site at a second location. different from the first location;
authenticate a user utilizing a first site; and permit the authenticated user to utilize the first site.

2. The information processing apparatus according to claim 1, wherein the processor is configured to provide the authenticated user with usage information used to utilize the first site.

3. The information processing apparatus according to claim 2, wherein the, first site is locked and the usage information is information used to unlock the first site.

4. The information processing apparatus according to claim 3, wherein the processor is configured to output a paper sheet having printed information used to unlock the

5. The information processing apparatus according to claim 4, wherein the, processor is configured to output the paper sheet on a per user basis if the users utilize the first site.

6. The information processing apparatus according to claim 3, wherein the first site is permitted to be used if the information used unlock the first site is combined with authentication information.

7. The information processing apparatus according to claim 4, wherein the first site is permitted to be used if the information used to unlock the first site is combined with authentication information.

8. The information processing apparatus according to claim 5, wherein the, first site is permitted to be used if the information used to unlock the first site is combined with authentication information.

9. The information processing apparatus according to claim 1, wherein the processor is configured to, until a predetermined period of time has elapsed since authentication of the, user utilizing the first site, not perform, a process including authenticating a user.

10. The information processing apparatus according to claim 1, wherein the, processor is configured to, if no other users utilizing the first sites are present, permit the authenticated user to change the first sites.

11. The information processing apparatus according to claim 1, wherein the processor is configured to:
manage usage logs of the first sites on the users; and
provide toe users with information to reduce usage fees of the first sites in view of the usage logs.

12. The information processing apparatus according to claim 1, wherein the processor is configured to cause a display to display usage statuses of the first sites.

13. The information processing apparatus according to claim 1, wherein the, processor is configured to:
provide a service, excluding managing the first sites; and
guide a user to the first site responsive to the service used v the user.

14. The information processing apparatus according to claim 1, wherein the processor is configured to:
provide a service excluding managing the first sites;
if the first site is used, cause a display to display information on the service; and
if the first site is not used, cause the display to display information or a reservation for the first site.

15. The information processing apparatus according to claim 1, wherein the processor is configured to, if the information processing apparatus malfunctions and is unable to permit the user to utilize the first site, permit an information processing apparatus managing the second site to permit the user to utilize the first site.

16. The information processing apparatus according to claim 1, wherein the processor is configured to, if the first site has been reserved by another information processing apparatus other than the information processing apparatus, permit the user having reserved the first, site to utilize the first site by authenticating the user.

17. The information processing apparatus according to claim 16, wherein the processor is configured to, if the first site has been reserved by the other information processing apparatus, cause a display to display information identifying the user having reserved the first site.

18. The information processing apparatus according to claim 1, wherein the processor is configured to:
permit the user having reserved the first site to utilize the first site by authenticating the user; and
if a user is detected when the first site is not reserved, cause a display to display information on a service excluding managing the first sites.

19. An information processing method comprising:
providing a service to a plurality of users by receiving operations from the users;
managing a plurality of first sites at a first location but not managing a second site at a second location different from the first location;
authenticating a user utilizing a first site; and
permitting the authenticated user to utilize the first site.

20. A non-transitory computer readable medium storing a program causing a computer to execute a process, the process comprising:
providing a service to a plurality of users by receiving operations from the users;
managing a plurality of first sites at a first location but not managing a second site at a second location different from the first location;
authenticating a user utilizing a first site; and
permitting the authenticated user to utilize the first site.
